(19) United States
(12) Patent Application Publication
(10) Pub. No.: US 2018/0025114 A1
(43) Pub. Date: Jan. 25, 2018

(54) SYSTEMS FOR MONITORING, UPDATING, AND FACILITATING PATIENT CARE

(71) Applicant: CareQuo, LLC, St. Paul, MN (US)

(72) Inventor: Michelle Chaffee, Minneapolis, MN (US)

(21) Appl. No.: 15/218,506

(22) Filed: Jul. 25, 2016

(51) Int. Cl. G06F 19/00

(52) U.S. Cl. CPC G06F 19/322; G06F 19/3425

(57) ABSTRACT

The present application is generally directed to systems for monitoring, updating, and facilitating care of a patient. The system may have a database storing medical data for the patient, a platform communicatively coupled to the database, and a user interface accessible by one or more users. The platform may have an access control module for authenticating user credentials and for controlling read and write access for users by providing a plurality of assignable user access levels. The user interface may have a social page for facilitating communication between users, a medical page for accessing medical data for the patient, and a care team page for accessing data related to a care team, which may include one or more users. In some embodiments, each of the one or more users may have an assigned access level for each of the social page, medical page, and care team page.

### FIELD OF THE INVENTION

The present application is generally directed to monitoring, updating, and facilitating patient care and wellbeing. Particularly, the present application relates to systems for providing a platform allowing for communication of updates, information, alerts, instructions, and other data in order to facilitate monitoring and management of a patient's care and wellbeing.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Various parties may be involved in or take an interest in the care and wellbeing of a patient, such as an elderly patient, a patient with a physical or mental incapacity, or other individual. Doctors, nurses, physical therapists, in-home caregivers, family members, friends, neighbors, and others may provide assistance in, or have an interest in, caring for or simply looking after the patient. It may be beneficial for the parties involved in or having an interest in a patient's care or wellbeing to communicate with one another and/or to have access to documents and information related to the patient's care or wellbeing. Such communication may be challenging where multiple parties having different roles or levels of interest and/or where parties are geographically separated. Moreover, it may be difficult to manage the various roles, tasks, and duties of the various individuals needed to facilitate care or monitor the wellbeing of a patient.

Thus, there is a need in the art for systems for improved monitoring and tracking of a patient's care or wellbeing. Particularly, there is a need for system through which a patient's family members, friends, doctors, caregivers, and other individuals having an interest in caring for or looking after the patient can securely access care data and communicate with one another regarding the patient's care or wellbeing.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a system for facilitating care of a patient. The system may have a database storing medical data for the patient, a platform communicatively coupled to the database, and a user interface accessible by one or more users. The platform may have an access control module for authenticating user credentials and for controlling read and write access for users by providing a plurality of assignable user access levels. The user interface may have a social page for facilitating communication between users, a medical page for accessing medical data for the patient, and a care team page for accessing data related to a care team, which may include one or more users. In some embodiments, each of the one or more users may have an assigned access level for each of the social page, medical page, and care team page. The plurality of user access levels may include an administrator access level, a family member access level, and a medical professional access level in some embodiments. The administrator access level may permit a user the ability to view, add to, edit, and delete content on each of the social page, medical page, and care team page. The administrator access level may further permit a user the ability to add and delete users from the care team and assign access levels for users. The family member access level may permit a user the ability to view, add to, edit, and delete content on at least the social page, and may restrict access to edit and delete content on the care team page. Further, the medical professional access level may permit a user the ability to view, add to, edit, and delete content on at least the medical page, and may restrict access to edit and delete content on the care team page. In some embodiments, the plurality of user access levels may include a friend access level, permitting a user the ability to view, add to, and edit content on the social page, and restricting access to edit and delete content on the medical page and care team page. In some embodiments, the social page may display communicative posts made by users. The one or more users may upload documents to the medical page in some embodiments. The platform may further include an analytics module for analyzing the medical data for the patient, and/or an alerts module for sending alerts to at least one of the one or more users. The user interface may include a medications page for accessing data related to current medications of the patient in some embodiments, and each of the one or more users may have an assigned access level for the medications page. Further, the user interface may have a biometrics page for accessing biometrics data for the patient, the biometrics data including data related to at least one of: the patient's blood pressure, the patient's blood sugar, the patient's daily activity, the patient's heart rate, the patient's temperature, the patient's weight, the patient's pain scale, the patient's oxygen saturation or use, the patient's CA 125, the patient's inhibin, and the patient's INR. Each of the one or more users may have an assigned access level for the biometrics page. The user interface may further include a calendar page for accessing scheduling data for the patient, and each of the one or more users may have an assigned access level for the calendar page. In some embodiments, the user interface may include a new page for accessing news data related to care of the patient, and each of the one or more users may have an assigned access level for the news page. Additionally, the user interface may have a legal page for accessing legal data for the patient, and each of the one or more users may have an assigned access level for the legal page.

The present disclosure, in one or more additional embodiments, relates to a user interface for facilitating care of a patient and providing one or more users with access to health data for the patient. The user interface may have a social page for facilitating communication among the users, a medical page for accessing the medical data for the patient, and a care team page for accessing data related to a care team, made up of one or more users. In some embodiments, access to the user interface may be controlled by a plurality of assignable user access levels, each user access level including, for each of the social page, medical page, and care team page, at least one of read and write permissions. The plurality of user access levels may include an administrator access level, a family member access level, and a medical professional access level. The administrator access level may permit a user the ability to view, add to, edit, and delete content on each of the social page, medical page, and care team page, and may further permit a user the ability to add and delete users from the care team page. The family member access level may permit a user the ability to view, add to, edit, and delete content on at least the social page, and may restrict access to edit and delete content on the care team page. The medical professional access level may permit a user the ability to view, add to, edit, and delete content on at least the medical page, and may restrict access to edit and delete content on the care team page. The plurality of user access levels may further include a friend access level in some embodiments. The friend access level may permit a user the ability to view, add to, and edit content on the social page, and may restrict access to edit and delete content on the medical page and care team page. In some embodiments, the user interface may have a medications page for accessing data related to current medications for the patient, and each user access level may have, for the medications page, at least one of read and write permissions. The user interface may further have a biometrics page for accessing biometrics data for the patient. The biometrics data may include data related to at least one of: the patient's blood pressure, the patient's blood sugar, the patient's daily activity, the patient's heart rate, the patient's temperature, the patient's weight, the patient's pain scale, the patient's oxygen saturation or use, the patient's CA 125, the patient's inhibin, and the patient's INR. Moreover, each user access level may include, for the biometrics page, at least one of read and write permissions. The user interface may include a calendar page for accessing scheduling data for the patient, and each user access level may include, for the calendar page, at least one of read and write permissions. The user interface may include a news page for accessing news data related to care of the patient, and each user access level may include, for the news page, at least one of read and write permissions. Further, in some embodiments, the user interface may include a legal page, and each user access level may include, for the legal page, at least one of read and write permissions.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a diagram of a patient care system of the present disclosure, according to one or more embodiments.

FIG. 2 is a screenshot of a login page of a user interface of the present disclosure, according to one or more embodiments.

FIG. 3 is screenshot of a social page of a user interface of the present disclosure, according to one or more embodiments.

FIG. 4A is a screenshot of a patient vitals display portion of a user interface of the present disclosure.

FIG. 4B is a screenshot of a patient profile page of a user interface of the present disclosure.

FIG. 4C is another screenshot of the patient profile page of FIG. 4B, according to one or more embodiments.

FIG. 5 is a screenshot of a news page of a user interface of the present disclosure, according to one or more embodiments.

FIG. 6 is a screenshot of a calendar page of a user interface of the present disclosure, according to one or more embodiments.

FIG. 7 is a screenshot of a calendar entry window of the calendar page of FIG. 6, according to one or more embodiments.

FIG. 8 is a screenshot of a medical page of a user interface of the present disclosure, according to one or more embodiments.

FIG. 9 is another screenshot of the medical page of FIG. 8, according to one or more embodiments.

FIG. 10 is a screenshot of an upload file window of the medical page of FIG. 8, according to one or more embodiments.

FIG. 11 is another screenshot of the medical page of FIG. 8, according to one or more embodiments.

FIG. 12 is a screenshot of a condition information window of the medical page of FIG. 8, according to one or more embodiments.

FIG. 13 is a screenshot of a medications page of a user interface of the present disclosure, according to one or more embodiments.

FIG. 14 is screenshot of a prescription information window of the medical page of FIG. 13, according to one or more embodiments.

FIG. 15 is a screenshot of a biometrics page of a user interface of the present disclosure, according to one or more embodiments.

FIG. 16A is another screenshot of the biometrics page of FIG. 15, according to one or more embodiments.

FIG. 16B is an update biometric measurement window of the biometrics page of FIG. 15, according to one or more embodiments.

FIG. 16C is another screenshot of the biometrics page of FIG. 15, according to one or more embodiments.

FIG. 17 s a screenshot of a legal page of a user interface of the present disclosure, according to one or more embodiments.

FIG. 18 is another screenshot of the legal page of FIG. 17, according to one or more embodiments.

FIG. 19 is a screenshot of a care team page of a user interface of the present disclosure, according to one or more embodiments.

FIG. 20 is a screenshot of a new care team member window of the care team page of FIG. 19, according to one or more embodiments.

FIG. 21 is another screenshot of the care team page of FIG. 19, according to one or more embodiments.

### DETAILED DESCRIPTION

The present disclosure relates to systems for providing a platform for monitoring, updating, and facilitating patient care and/or monitoring an individual's wellbeing. The platform may be provided over a wired or wireless network and may allow various users to access, update, and communicate regarding a patient's medical care, activities, or overall wellbeing via a user interface. Users of the platform may be the patient, doctors, nurses, other caretakers or medical professionals, family members, friends, neighbors, or other individuals having an interest in a patient's or other individual's (each referred to herein simply as “patient”) care or wellbeing. Various users may have different levels of access through the user interface. The platform may provide access to information and documents related to the patient's care or wellbeing, such as medical records, prescription information, biometrics information, Health Insurance Portability and Accountability Act (HIPPA) documents and information, legal documents, and other documents and information. The platform may additionally provide access to schedule information for the patient or related to the patient's care or wellbeing, such as medication schedules, appointment times, and other events or appointments. The platform may provide means of communication among the users, and may have a social aspect. A platform of the present disclosure may allow individuals to monitor, update, and facilitate a patient's care or monitor wellbeing as a care team.

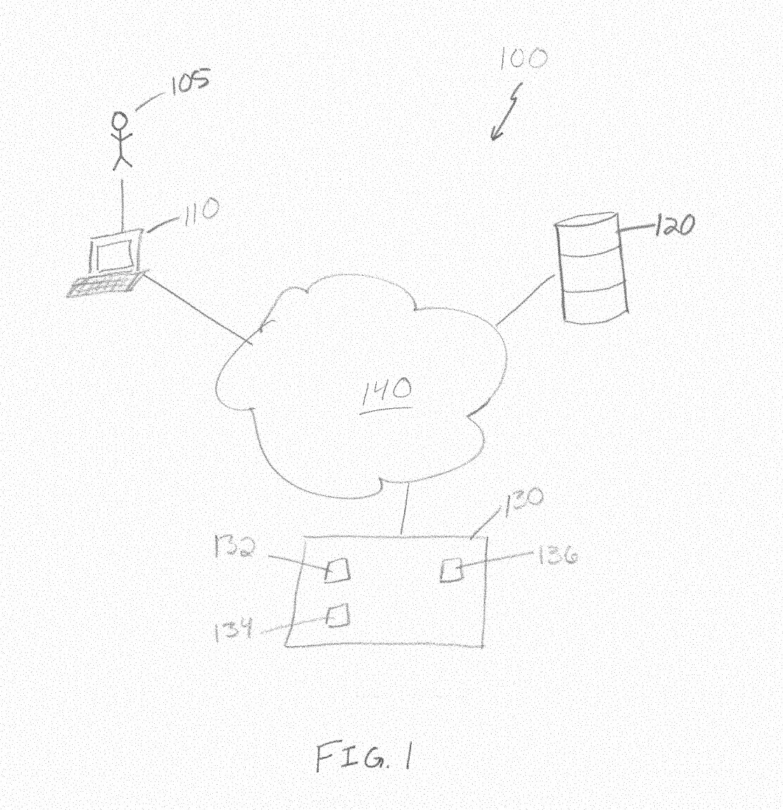

Turning now to FIG. 1, a patient care system 100 of the present disclosure is shown. The system 100 may generally operate to provide a platform for monitoring, updating, and facilitating a patient's care or wellbeing. The system 100 may have a user interface 110 accessible by a user 105. The system 100 may further have at least one database 120 storing data accessible by the user interface 110, and a platform 130 performing various platform processes. The user interface 110, at least one database 120, and processor 130 may be connected by a wired or wireless network 140, such as the Internet or a cloud network, for example.

The user interface 110 may be or include a software program, application, website, or other electronic interface. Additionally, the user interface 110 may be accessible via a desktop computer, notebook computer, tablet, smartphone, personal digital assistant (PDA), smart watch, or other suitable computing device. The user interface 110 may allow users to communicate with one another and/or view, add, remove, or edit information about a patient, related to a patient, or related to users. The user interface 110 may provide different levels of access for different users in some embodiments.

The user 105 may access the platform via the user interface 110. In some embodiments, the user 105 may be part of a care team. A care team may be a group of individuals who care for a patient or who have an interest in the patient's health. The user 105 may be a patient, or any of the patient's doctor, nurse, caretaker, personal care assistant, other health professional, family member, friend, or neighbor, for example. In some embodiments, the system 100 may include multiple users 105. Users may have different levels of access through the user interface 110 in some embodiments. For example, a user 105 may be an administrator in some embodiments. An administrator may have access that includes the ability to view, add, edit, and/or delete data, for example. In some embodiments, an administrator may generally have full access rights. An administrator may additionally have the ability to add, edit, and delete access rights for other users. Other users may have different access rights. For example, some users may have add and edit capabilities but may not be able to delete particular elements. In some cases, a user may have view only access to all or to particular portions of the data accessible on the system 100. Other users may have different view, add, edit, and delete rights to portions of the data available on the platform.

As described above, the system 100 may have at least one database 120. The database 120 may store information related to a patient or care or wellbeing of the patient. Information in the database 120 may be accessible via the user interface 110. Information in the database 120 may be received from a user or from one or more other sources. The database 120 may store such information as a patient profile, user profile, medical data, legal data, communications between users, scheduling data, biometrics data, or other data related to care of a patient or to users of the system 100. In some embodiments, the database 120 may store HIPPA information. The system 100 may have more than one database 120 in some embodiments. For example, the system 100 may have databases for different types of information. The system 100 may have a HIPPA database for storing HIPPA-eligible data and documents, a prescription medications database for storing prescription medication data, and/or other databases in some embodiments.

In some embodiments, the system 100 may have a platform 130. The platform 130 may have hardware and/or software for monitoring, updating, and facilitating patient care. The platform 130 may be accessible via the user interface 110. The platform 130 may have one or more modules in some embodiments, such as an access control module 132, a patient data module 134, and an alerts module 136.

The access control module 132 may control access to the platform 130 and database 120 from the user interface 110. For example, the access control module 132 may verify user login information entered at the user interface 110. The access control module 132 may operate to restrict or control a user's access permissions based on preset settings or settings chosen by an administrator, for example. The access control module 132 may ensure compliance with HIPPA standards or practices in some embodiments. It may be appreciated that a system of the present disclosure is capable of complying with applicable HIPPA standards or practices.

The patient data module 134 may control display and dissemination of data such as patient data, medical data, biometrics data, or other data added, updated, or deleted by a user. For example, the patient data module 134 may receive posts, comments, or other data submitted or contributed by one or more users. The patient data module 134 may further display the posts, comments, or other data to users via the user interface 110.

The alerts module 136 may provide an alert to one or more users in response to particular events. For example, an alert may be provided to one or more users after a user edits, adds, or otherwise changes patient data or other data accessible from the system 100. In some embodiments, an alert may be provided to one or more users in response to a scheduling conflict. In some embodiments, an alert may be provided to one or more users in response to an event such as an apparent missed medication dosage, a contraindicated medication, an unusual or concerning biometric data point, or an emergency event. The alerts module 136 may send alerts to particular users based on the users' access levels in some embodiments. For example, where a user has view only access, that user may be excluded from receiving particular alerts. Alerts may be provided by various means, such as by a popup notification, text message, email, voice message, or other suitable alert means. In some embodiments, users may determine which alerts they receive and by what means they are received.

In some embodiments, the platform 130 may have other or additional modules or other components. For example, the platform 130 may have an analytics module for tracking and/or analyzing biometric or other health data. The analytics module may analyze medication data for medicine contraindications, unusual data points, data trends, or other information. Additionally or alternatively, in some embodiments, the platform 130 may have a news module for providing data from one or more news sources or other sources to users via the user interface 110. For example, a news module may provide access to updated healthcare news data from one or more sources.

The system 100 may generally allow one or more users 105 to monitor, update, and facilitate care or wellbeing of a patient. In this way, information and documents in the database and/or accessible via the user interface 110 may generally relate to the patient. In some embodiments, the system 100 may provide for facilitating care or wellbeing of multiple patients.

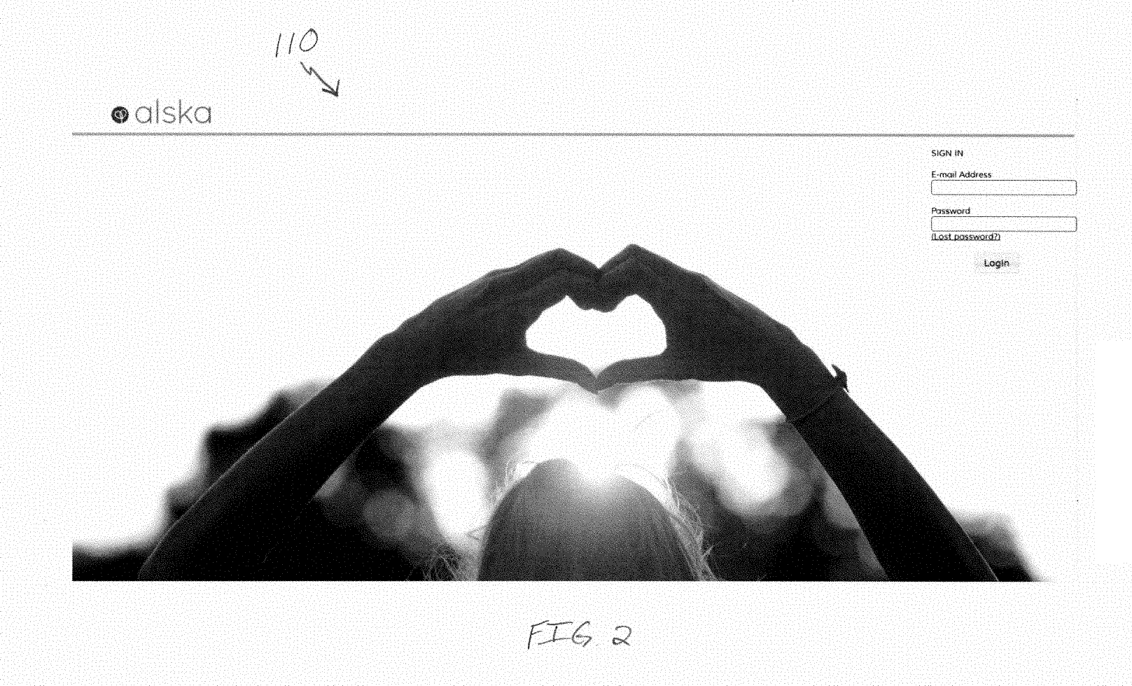

FIGS. 2-21 show exemplary embodiments of a user interface 110 whereby one or more users 105 may access the platform 130, database 120, and/or other components of the system 100. As described above, the user interface 110 may include a program, application, website, or other type of interface. As shown in FIG. 2, in some embodiments, the user interface 110 may prompt a user for login information before providing access to the system 100. Login information may include a username or email address and a password in some embodiments. However, other forms of identification verification may be used.

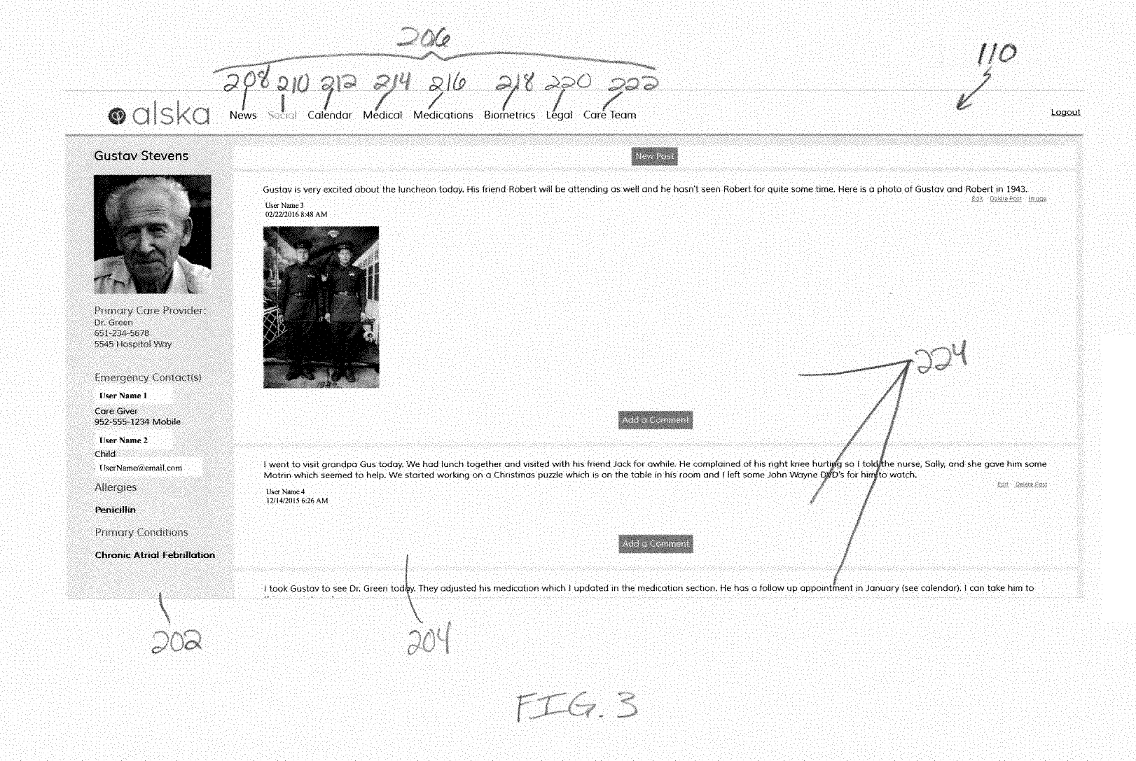

FIG. 3 shows an example page of the user interface 110. The user interface 110 may provide access to information, documents, and communications related to the patient. The user interface 110 may generally have any suitable layout with pages, displays, screens, links, tabs, buttons, and/or other layout options. As shown in FIG. 3, in some embodiments, the user interface 110 may have a patient vitals display portion 202, an information display portion 204, and a plurality of selectable tabs 206.

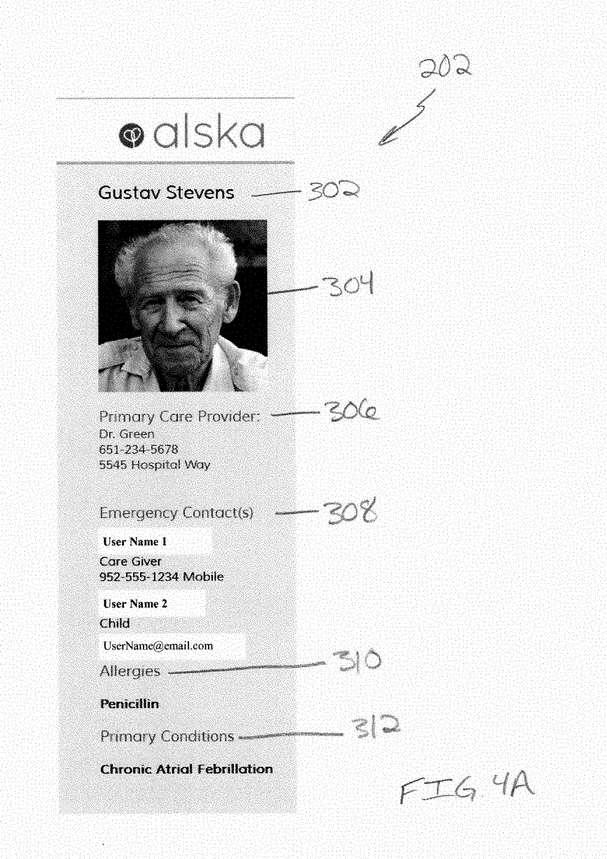

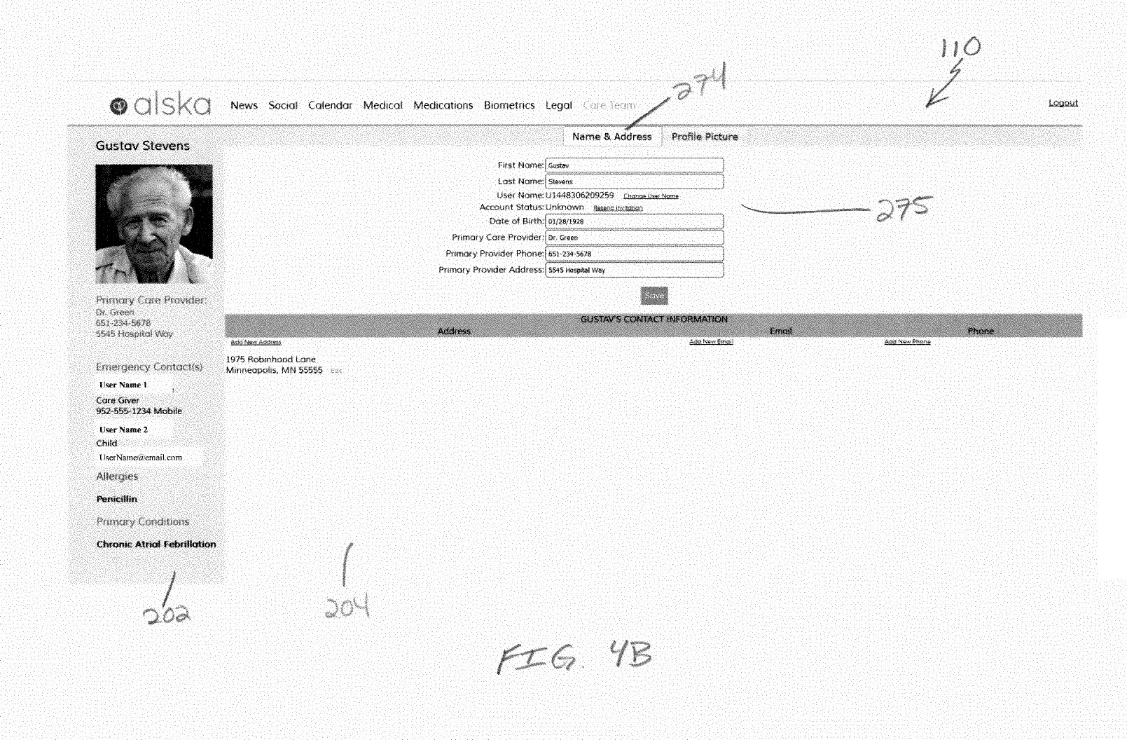

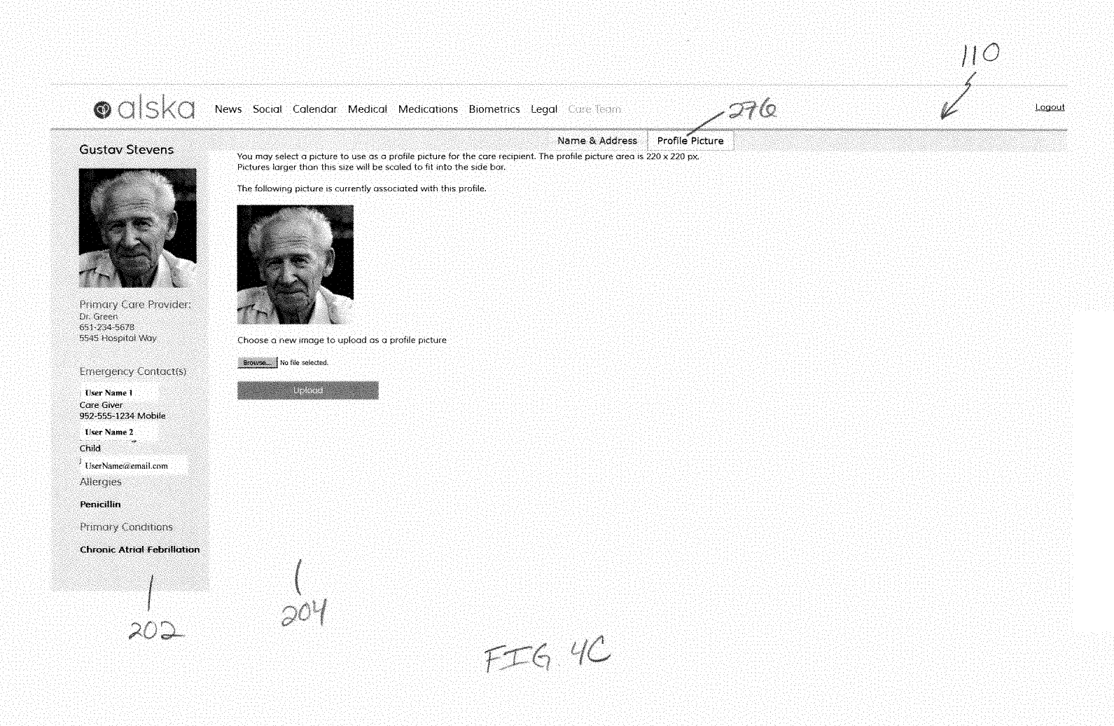

The patient vitals display portion 202 may display particular information related to the patient. For example, as shown in FIG. 4A, the vitals display portion 202 may include the patient's name 302 and a picture 304 of the patient. The patient vitals display 202 may include different information fields. For example, the patient vitals display 202 may display contact information for the patient's primary care provider 306 or other medical professional, and contact information for one or more emergency contacts 308, which may be the patient's family members, friends, or medical professionals, for example. The patient vitals display 202 may additionally show medical information such as the patient's allergies 310 and primary medical conditions 312. Other information fields may be displayed in the patient vitals display 202 in some embodiments, such as contact information for the patient or other information or links to information. In some embodiments, the patient vitals display 202 may remain visible on the various pages or navigation views of the user interface 110. That is, as shown in FIGS. 2-21 for example, while information displayed in the information display portion 204 may change based on navigation throughout the user interface 110, the patient vitals display portion 202 may remain visible. In other embodiments, the patient vitals display 202 may be, or be visible on, a separate page or navigable screen.

At least some of the information displayed in the patient vitals display 202 may be derived from a patient profile. FIG. 4B illustrates a patient profile page. The patient profile page may have one or more views, pages, or tabs. For example, the patient profile page may have a name and address tab 274, under which the patient's information may be added or edited on a patient information window 275. Patient information that may be added or edited in the patient information window 275 may include contact information, primary care provider information, biographical information, and/or other information. As shown in FIG. 4C, the patient profile page may have a profile picture tab 276 under which a profile picture may be added for the patient. A user 105 may add a patient profile picture by uploading an image from a local or remote database or device in some embodiments. In some embodiments, the user interface 110 may have capabilities permitting a user to take a picture for the patient profile directly via the user interface.

Turning back to FIG. 3, the information display portion 204 may display various data, documents, communications, or other information. As a user 105 navigates through the user interface 110, the information display portion 204 may display information that the user accesses through the various pages, screens, tabs 206, or other elements of the user interface. The information display portion 204 may contain buttons, links, or other navigation options depending on the content that is currently displayed.

The plurality of selectable tabs 206 may provide links for navigating throughout the user interface 110. The tabs 206 may differ based on the different information or documents available on the interface 110. In some embodiments, the tabs 206 may be customizable for a given patient or group of patients. The tabs 206 may each link to a particular page of the user interface 110. In some embodiments, as shown in FIG. 3, the user interface 110 may have a news page, which may be accessible by a news tab 208; a social page, which may be accessible by a social tab 210; a calendar page, which may be accessible by a calendar tab 212; a medical page, which may be accessible by a medical tab 214; a medications page, which may be accessible by a medications tab 216; a biometrics page, which may be accessible by a biometrics tab 218; a legal page, which may be accessible by a legal tab 220; and a care team page, which may be accessible by a care team tab 222. In some embodiments, the user interface 110 may open to a default one of the pages after a user 105 enters login information. As shown for example in FIG. 3, the user interface 110 may initially show the social page, otherwise accessible by the social tab 210, upon login. In other embodiments, the user interface 110 may initially display a different tabbed page or a different initial page, view, or landing page.

The social page, accessible by the social tab 210 and shown in FIG. 3, may allow users 105 to communicate with and/or interact with one another. For example, users 105 may post messages, which may include images, videos, and/or links to other content. The social page may display a series of posts 224 made by users 105, which may be shown with a most recent post listed at the top of the page, for example. Users 105 may scroll through older posts in some embodiments. A user 105 may edit or delete a post previously made by the user or by others in some embodiments, typically depending on the access rights given to the user. Users 105 may additionally comment on posts made by one another. Some users 105 may have no access, view only access, or other limited access to the social page. Other users may have write access and may be able to add new posts to the social page and/or edit or delete previously added posts. The social page may generally allow users to comment on or share thoughts about the patient's wellbeing, healthcare, daily activities, and other topics.

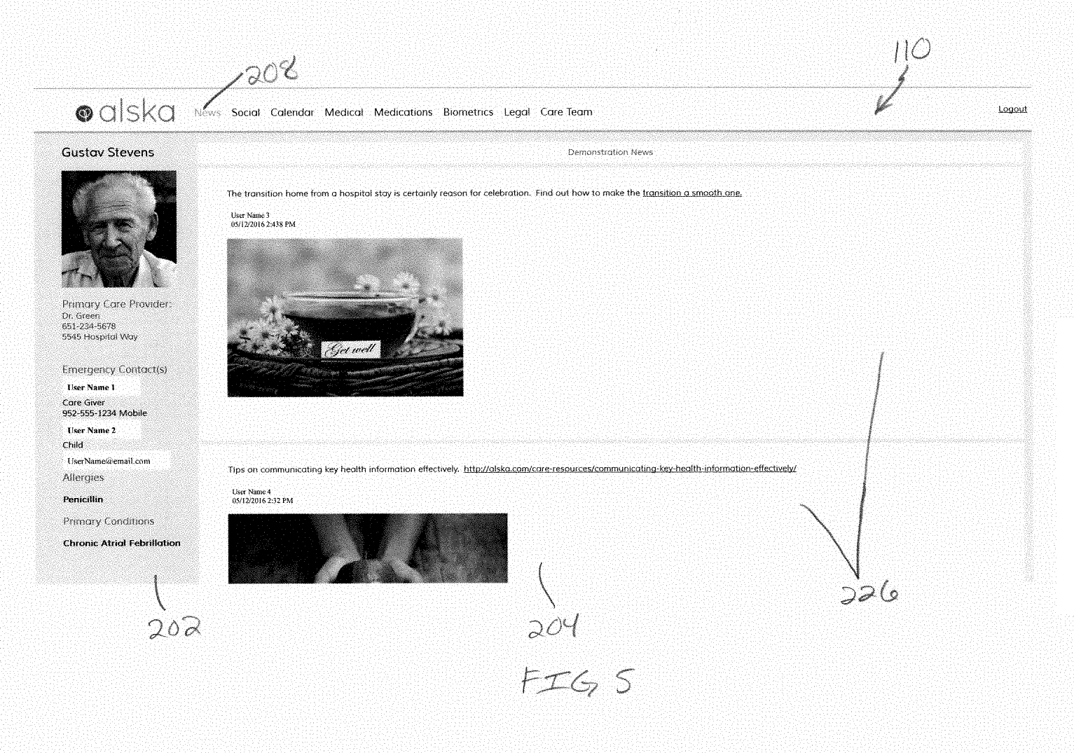

FIG. 5 shows an example of the news page of the user interface 110, accessible by the news tab 208. The news page may display news stories, web content, articles, etc. 226 related to healthcare, the patient's particular conditions, current events, or other types of news. In some embodiments, the news stories, web content, articles, etc. may include images, videos, and/or links to additional content. In some embodiments, the news page may automatically populate and/or update with recent or applicable content from one or more sources. In some embodiments, a user 105 may have the ability to customize the type of content that populates on the news page. Additionally, in some embodiments, users 105 may have the ability to post content or links to content on the news page. The news page may generally allow users to find important or applicable information related to the patient's care or wellbeing.

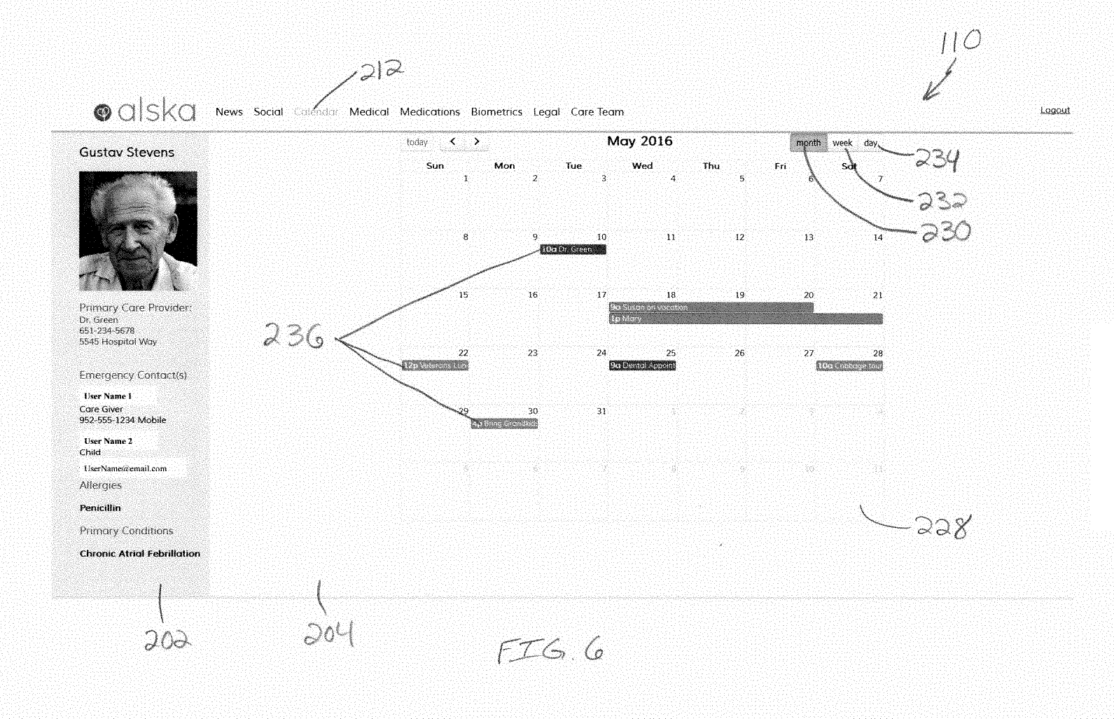

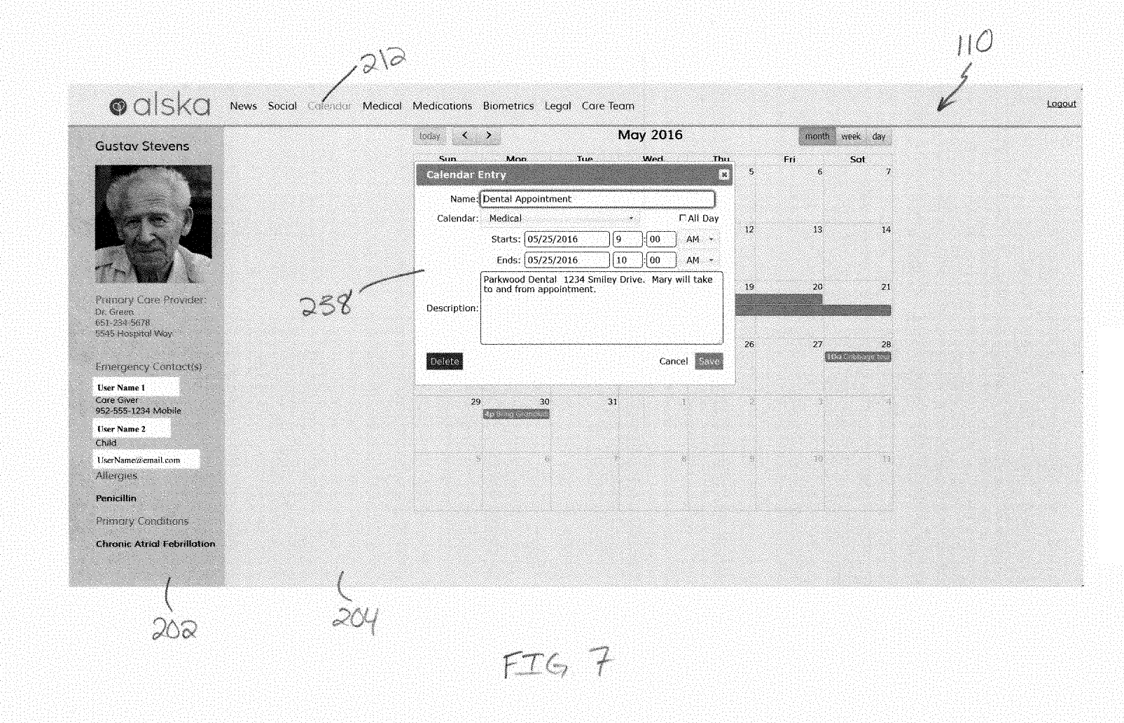

FIG. 6 shows an example of the calendar page of the user interface 110, accessible by the calendar tab 212. The calendar page may display a calendar 228. The calendar 228 may be configured to display one or more appointments or events 236. The calendar 228 may have different views in some embodiments. For example, month 230, week 232, and day 234 buttons may allow the calendar 228 to be viewed as a monthly, weekly, or daily schedule. The one or more appointments or events 236 may relate to care of the patient and/or schedules of one or more users or caretakers. For example, the calendar 228 may show the patient's medical appointments, social events, and other activities or appointments. The calendar may additionally show care takers' or other users' care schedules, vacation times, visiting times, or other scheduling information. In some embodiments, the calendar page may have more than one calendar 228. For example, users may have access to a medical calendar, a social calendar, and/or other calendars for different types of appointments or events. In some embodiments, the multiple calendars may be viewable as a single calendar, with events corresponding to the different calendars appearing in different colors, for example. In other embodiments, calendar events may be color coded for different purposes. Some users 105 may have no access, view only access, or other limited access to the calendar page. Other users may have write access and may be able to add new events to the calendar, and/or edit or delete previously added events. FIG. 7 shows a calendar entry window 238. The calendar entry window 238 may allow some users to edit existing appointments or events 236 or add new appointments or events. The calendar entry window 238 may open as a popup window, as shown in FIG. 7, in some embodiments. In other embodiments, the calendar entry widow 238 may open as a new page or screen. The calendar entry window 238 may have various data fields for editing or entering a calendar entry. For example, a user may enter the name of the calendar entry, the start and end date and time, and a description of the event. Additionally, the user may select an appropriate calendar or event type for the calendar entry. For example, a user may select from a drop down menu whether the calendar entry applies to the medical calendar, social calendar, or other calendar. The calendar page may also generally allow users to access and share scheduling information with one another, so as to coordinate the patient's care.

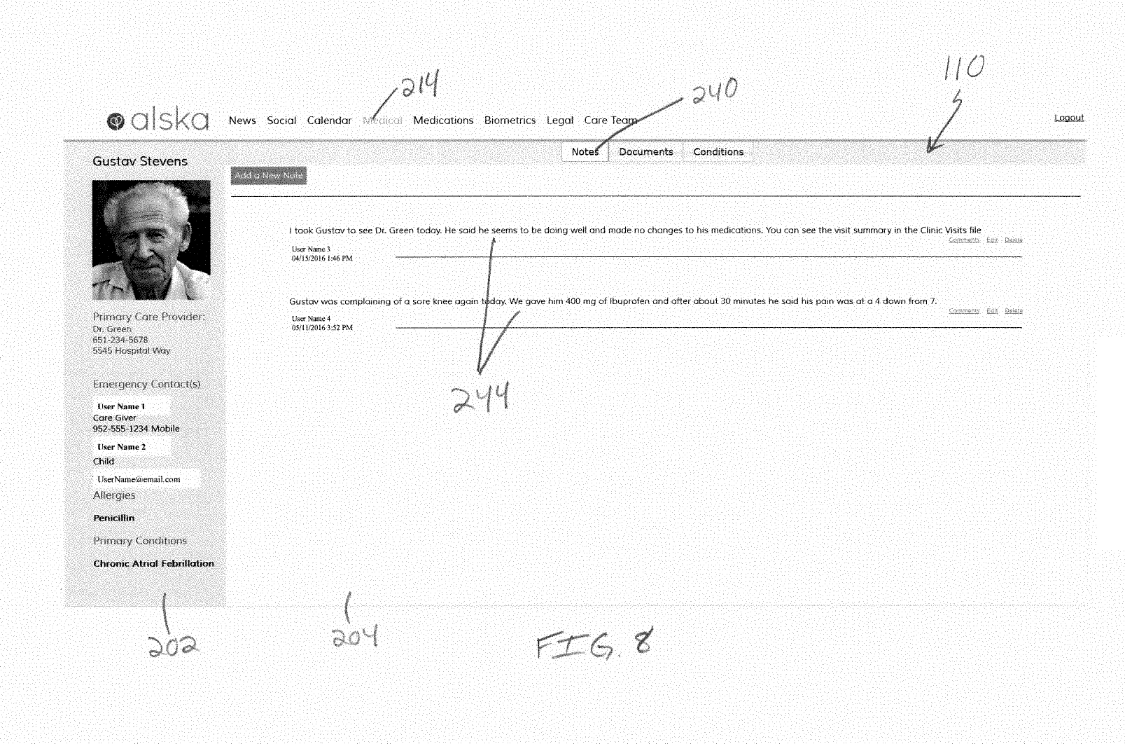

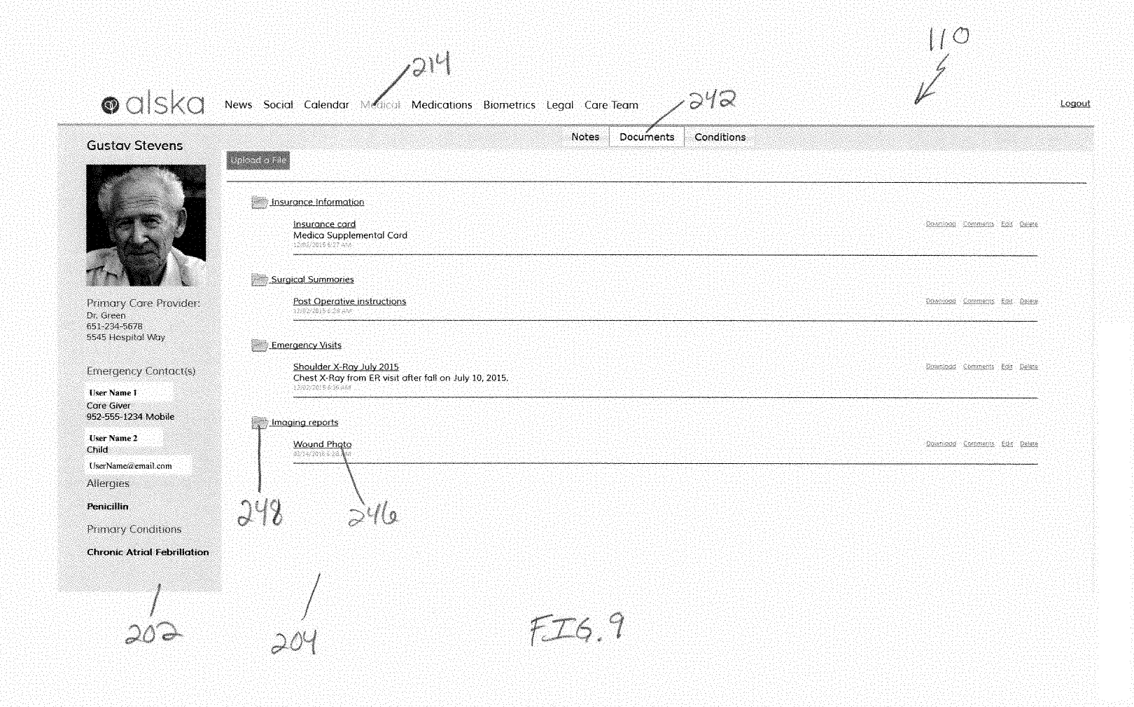

FIG. 8 shows an example of the medical page of the user interface 110, accessible by the medical tab 214. The medical page may have multiple internal views, pages, links, or tabs in some embodiments. For example, a notes tab 240 may display notes 244 added by users. Users 105 may comment on notes added by others and/or add new notes. Some users 105 may have the ability to edit and/or delete notes posted by others. Notes may relate to general medical issues, concerns, doctors' visits, and/or other information. As shown in FIG. 9, a documents tab 242 may display documents 246 related to the patient's care or wellbeing. Documents 246 may include photos, imaging documents such as X-ray imaging documents, doctors' instructions such as post-operative instructions, insurance documents such as insurance cards, health history documents, family history documents, and other documents. The documents 246 may be added or uploaded to the system 100 by users 105 in some embodiments. Some users 105 may have no access, view only access, or other limited access to the documents. Other users 105 may be able to upload new documents 246 and/or edit or delete previously added documents. In some embodiments, users 105 may have the ability to post comments on documents 246 so as to discuss the documents with other users or ask questions about the documents, for example. Users 105 may additionally have an option to download a copy of a document 246 available through the user interface 110. The documents tab 242 of the medical page may generally allow users to securely store and access important medical information in one conveniently accessible location.

The documents 246 may be organized into digital folders 248 in some embodiments. Some examples of folders include health history, occupational therapy, dental, optometry/ophthalmology, progress notes, imaging reports, insurance information, advanced directives, surgical summaries, clinic visits, emergency visits, hospitalizations, labs and test results, primary and specialty providers, and physical therapy. Additional or alternative document folders 248 may be used as well. In some embodiments, some users 105 may have to ability to customize folders 248. For example, users 105 may choose folders 248 from a predetermined list and/or may create new folders, edit folders, and delete folders.

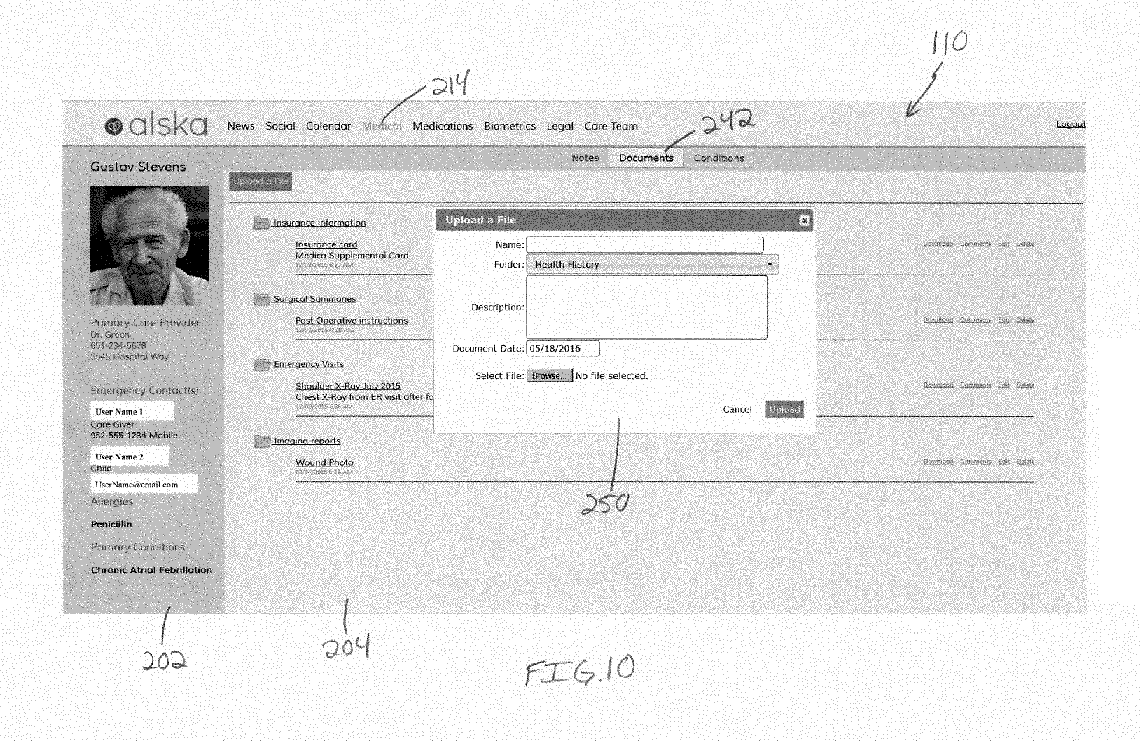

FIG. 10 illustrates an upload file window 250 for uploading a new document to the system 100. As shown, the upload file window 250 may have various fields where a user 105 may enter information about the document. For example, the user 105 may provide a document name, description, date, and/or other information. The user 105 may select or name a folder 248 under which the new document may be accessible. In some embodiments, the user 105 may then have the ability to browse an appropriate database or device for the new document to be uploaded, or otherwise identify the new document to be uploaded.

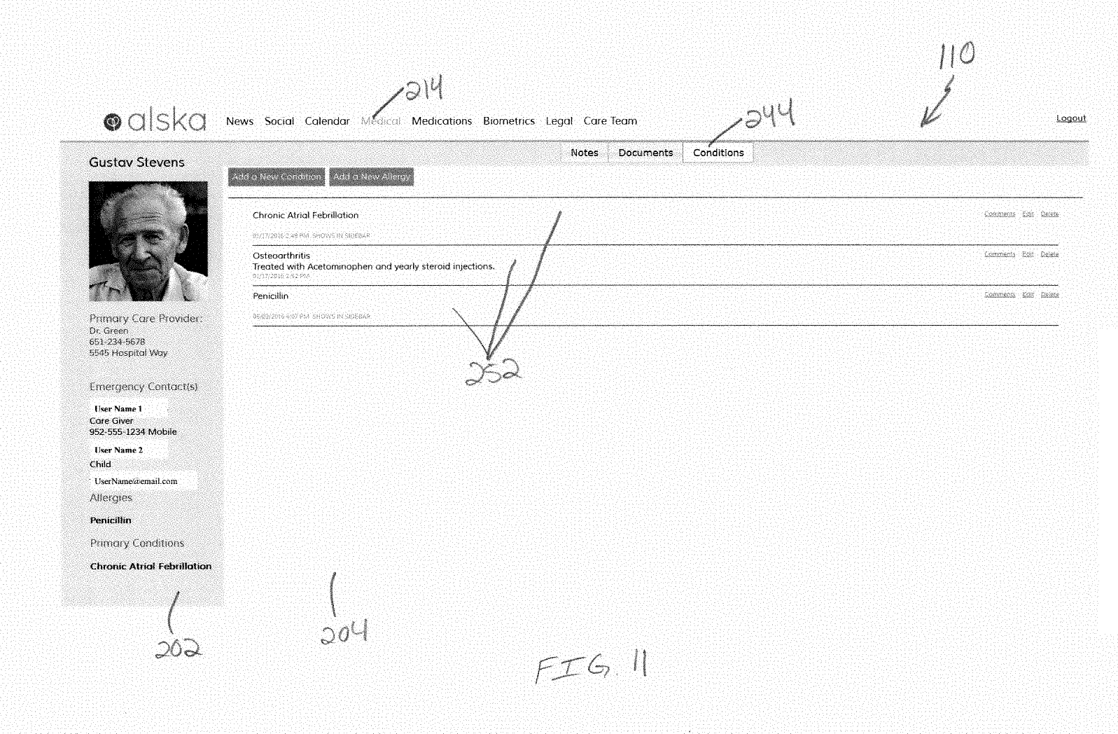

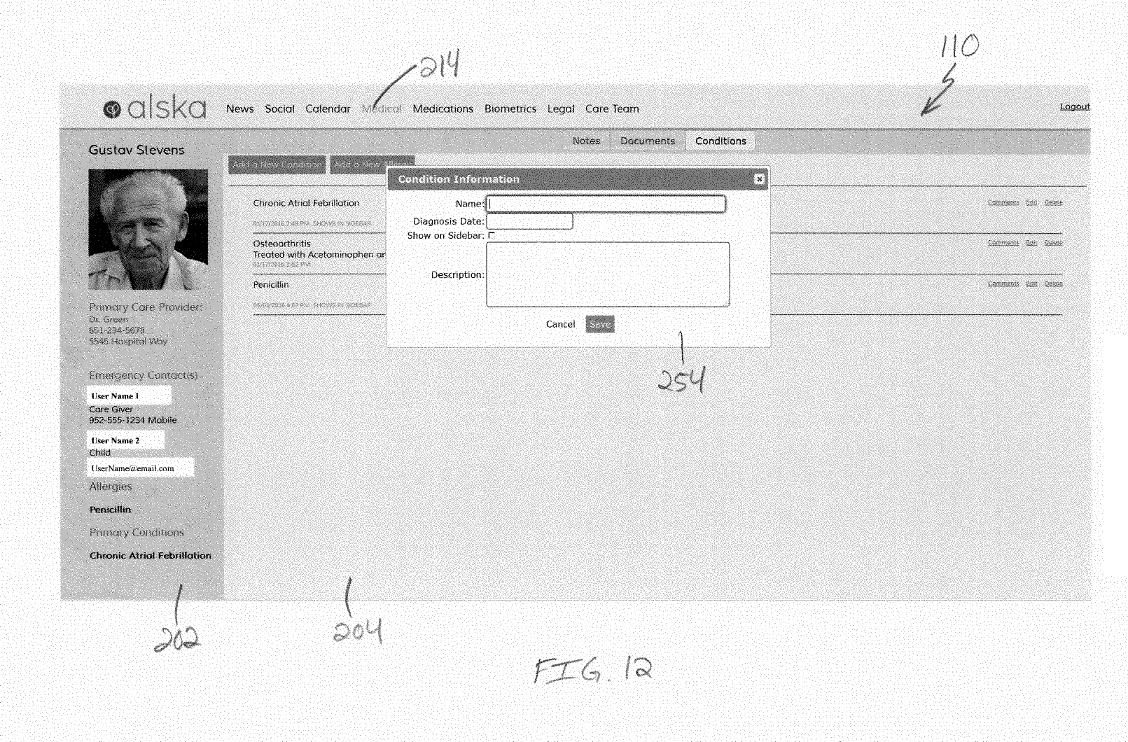

As shown in FIG. 11, the medical page may additionally have a conditions tab 244. The conditions tab 244 may display medical conditions and/or allergies 252 of the patient. Depending on access permissions, users 105 may have the ability to view conditions and/or allergies, add new conditions and/or allergies, and edit, delete, and/or comment on conditions and/or allergies. FIG. 12 illustrates a condition information window 254 for adding a new condition or editing a condition. The condition information window 254 may have various fields where a user 105 may enter information about the condition. For example, the user 105 may provide a condition name, diagnosis date, and description of the condition. The user 105 may additionally have an option to display the condition on the patient vitals display portion 202. Similarly, an allergy information window may have similar options for adding or editing an allergy in the conditions tab 244.

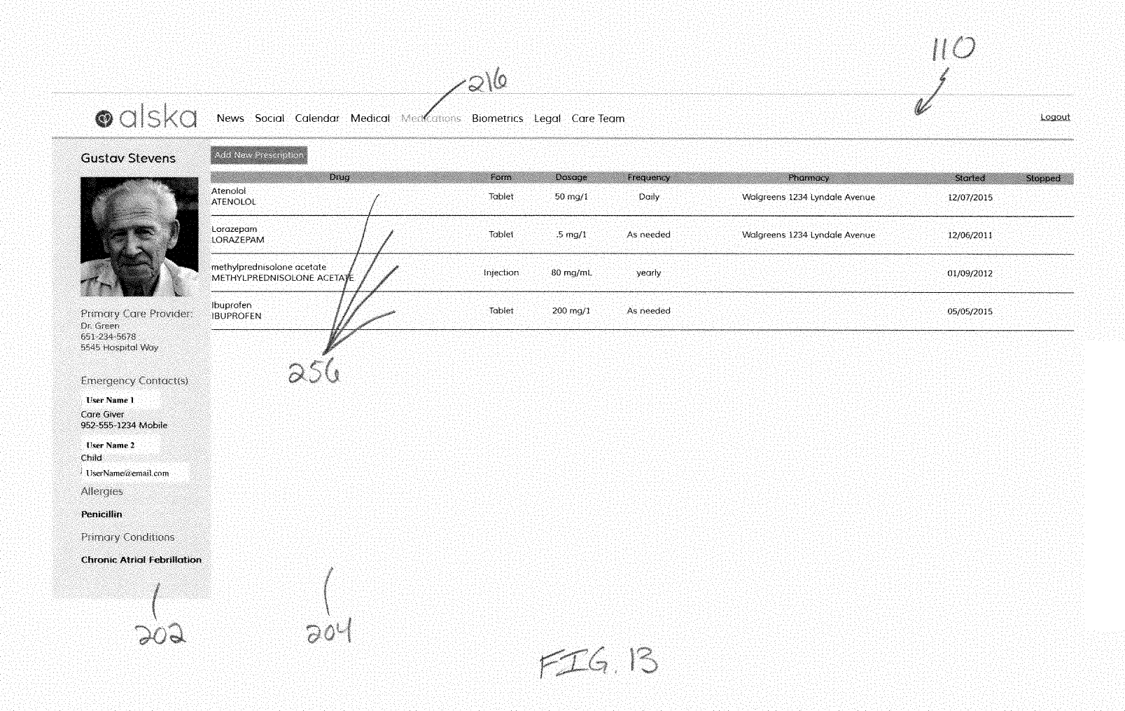

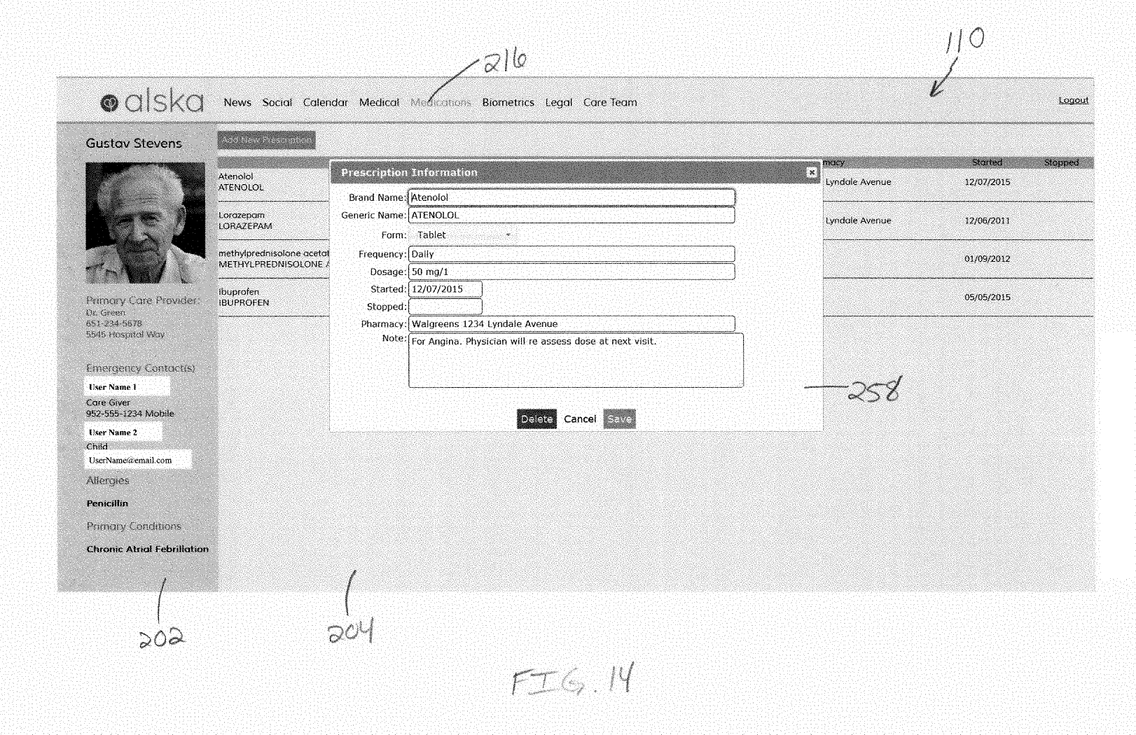

FIG. 13 shows an example of the medications page of the user interface 110, accessible by the medications tab 216. The medications page may display a list of medications 256 prescribed to the patient, currently being taken by the patient, or previously taken by the patient. Some users 105 may add, edit, and/or delete medications 256 on the medications page. FIG. 14 illustrates a prescription information window 258 for adding or editing a listed medication 256. As shown, the prescription information window 258 may have particular fields for entering information about the medication 256. For example, a user 105 may enter the brand name, generic name, frequency, dosage, date started, date stopped, pharmacy information, and/or additional notes for a medication 256 in the prescription information window 258. Additionally, the user 105 may enter the form in which the medication is taken, such as tablet, injection, liquid, or other forms. In some embodiments, the form of medication or other fields of the prescription information window 258 may be filled by the user 105 selecting an option from a dropdown list. Moreover, in some embodiments, the user 105 may have access to a database of known or common medications from the medications page of the user interface 110. Such a database may assist the user 105 in completing fields of the prescription information window 258. For example, if the user 105 enters the first few letters of a brand name or generic name medication, the system 100 may search the medications database for matching medication names and may automatically populate a list of possible medication that the user may be adding. Such medications database may additionally store commonly prescribed dosages and/or frequencies of medications in some embodiments. When the user 105 enters a new medication, the system 100 may automatically suggest and/or allow the user to select from the commonly prescribed dosages and/or frequencies of the medication being added. The medications page may generally allow users to maintain and have access to a record of medications, including prescription medications, supplements, and/or other medications taken by the patient.

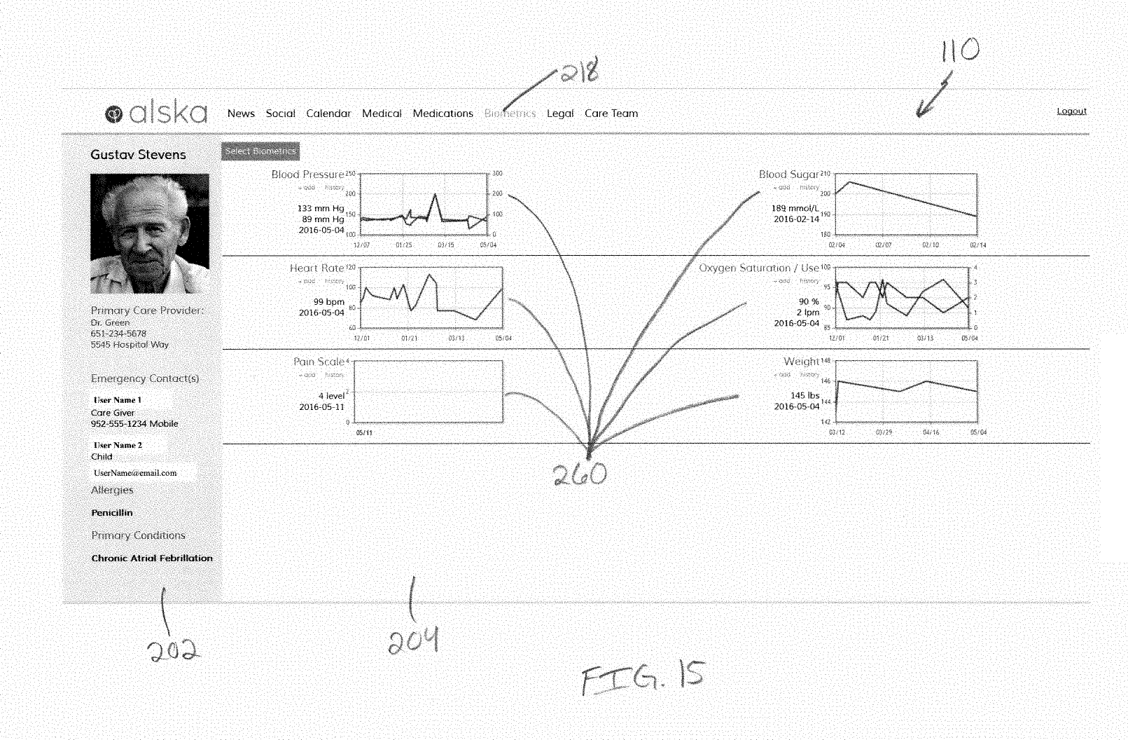

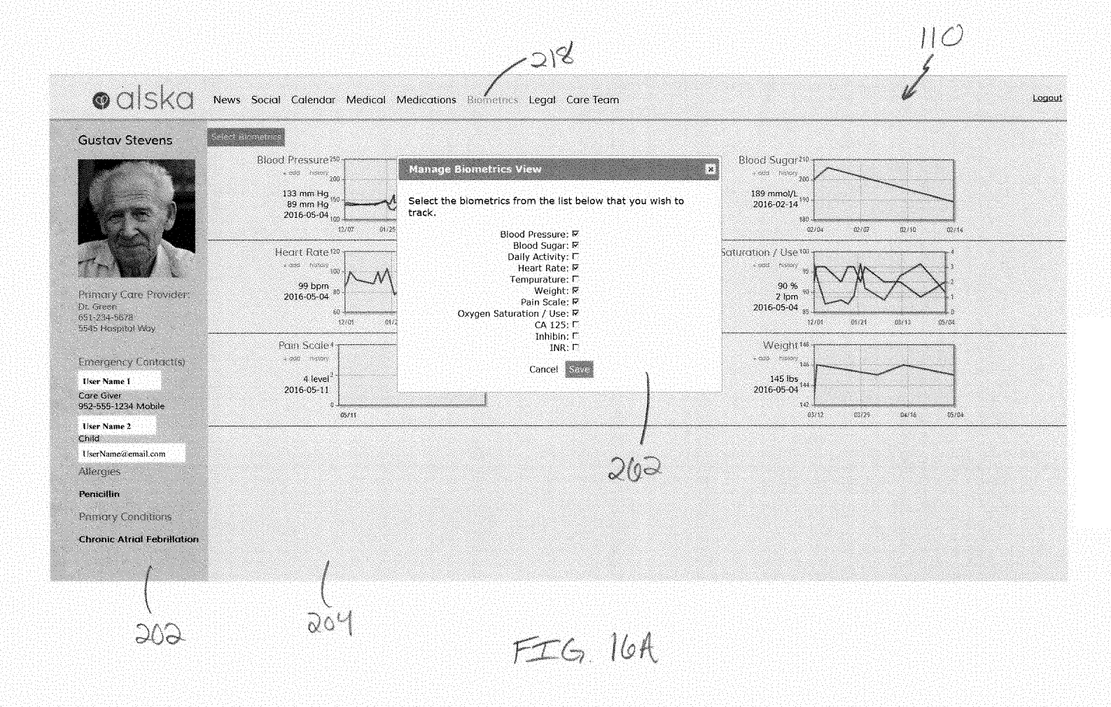

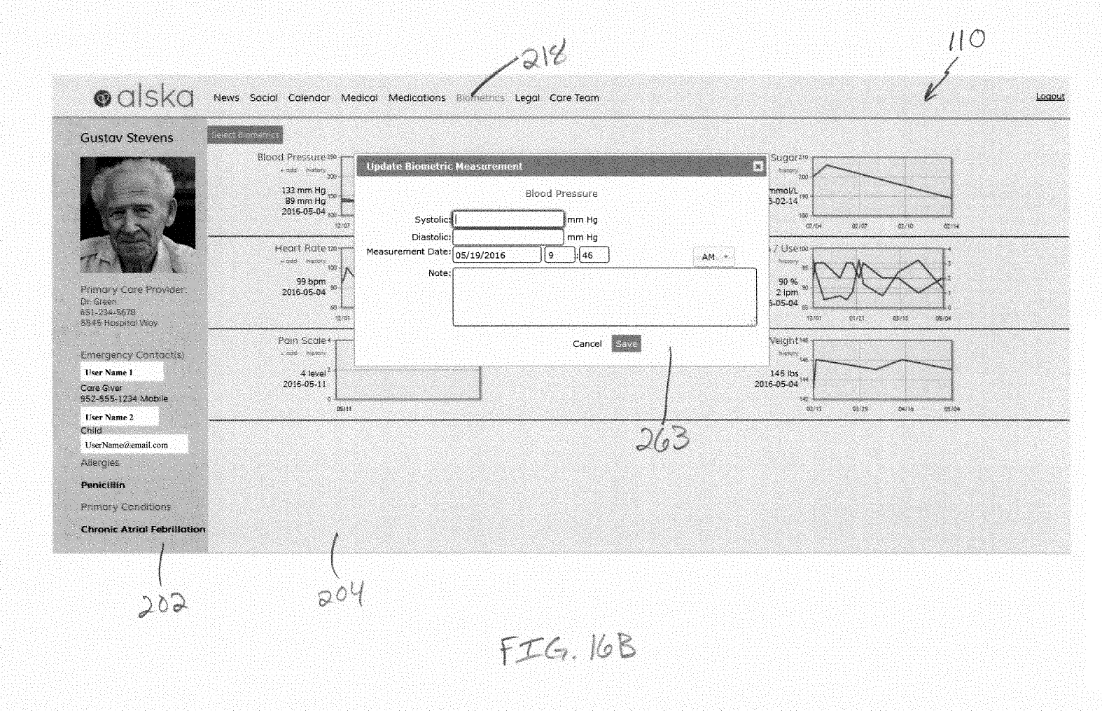

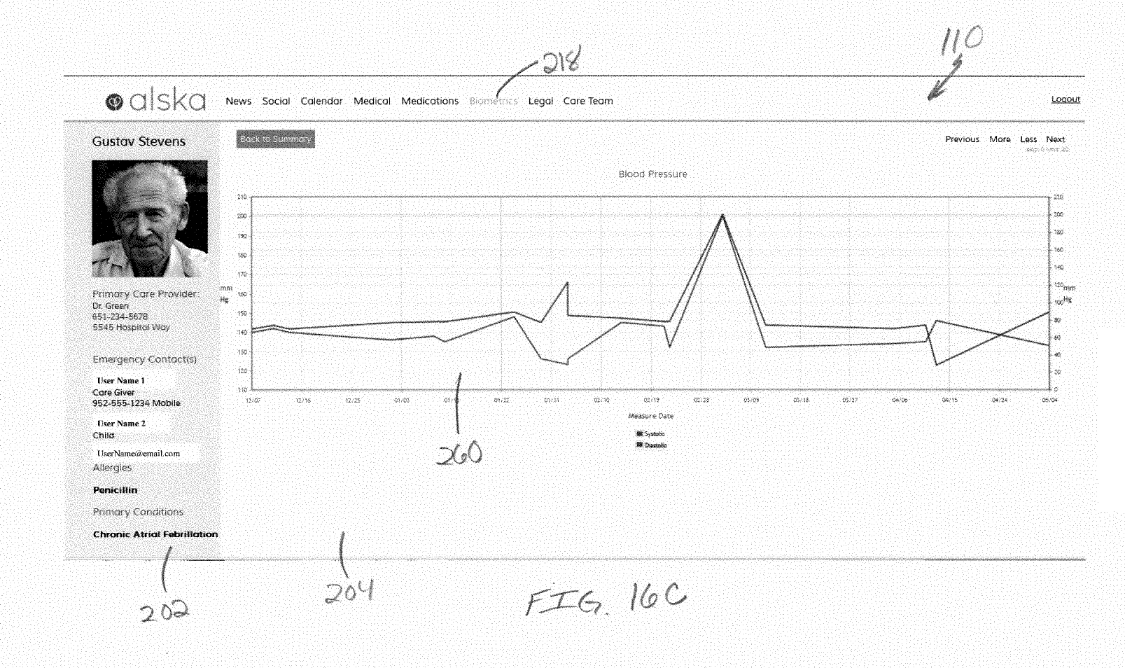

FIG. 15 shows an example of the biometrics page of the user interface 110, accessible by the biometrics tab 218. The biometrics page may display one or more patient biometrics 260. Biometrics 260 may include blood pressure, blood sugar, daily activity, heart rate, temperature, weight, pain scale, oxygen saturation/use, cancer antigen (CA) 125, inhibin, internal normalized ratio (INR), and/or other data. FIG. 16A shows a manage biometrics window 262 wherein a user may identify biometrics 260 to track or view. Once a biometric 260 is added to the biometrics page, data points may be added for the biometric. For example, FIG. 16B shows an update biometric measurement window 263 for the blood pressure biometric 260, whereby a data point including a blood pressure measurement, along with date and time taken, and any notes may be added to the biometrics page. Multiple data points entered for a biometric 260 may be tracked over time. In some embodiments, the entered data points for a biometric 260 may be displayed as a graph, chart, or table. This may allow users 105 to see trends in biometric data. From the biometrics page, a user 105 may further select and access individual biometrics 260 for a more detailed view. For example, as shown in FIG. 16C, a biometric 260, such as blood pressure, may be selected and displayed as a line graph showing data points as recorded over time. In some embodiments, the user 105 may have the option to view the data for a biometric 260 in different ways. For example, the user 105 may adjust the time period for which the biometric data is displayed, the type of graph, chart, or table displayed, and/or other options. The biometrics page may generally allow users 105 to track and monitor important health data for the patient.

In some embodiments, the biometrics page may be updatable by way of a device. For example, a blood pressure monitoring device, heart rate monitoring device, or other device used by the patient, a care taker, or a medical professional may send data to the system 100 via a Wi-Fi, Bluetooth, or other wired or wireless connection or network. In this way, some biometrics data may be continuously or periodically updated via the device. The data may be sent from the device automatically or may be sent by action of a user of the device.

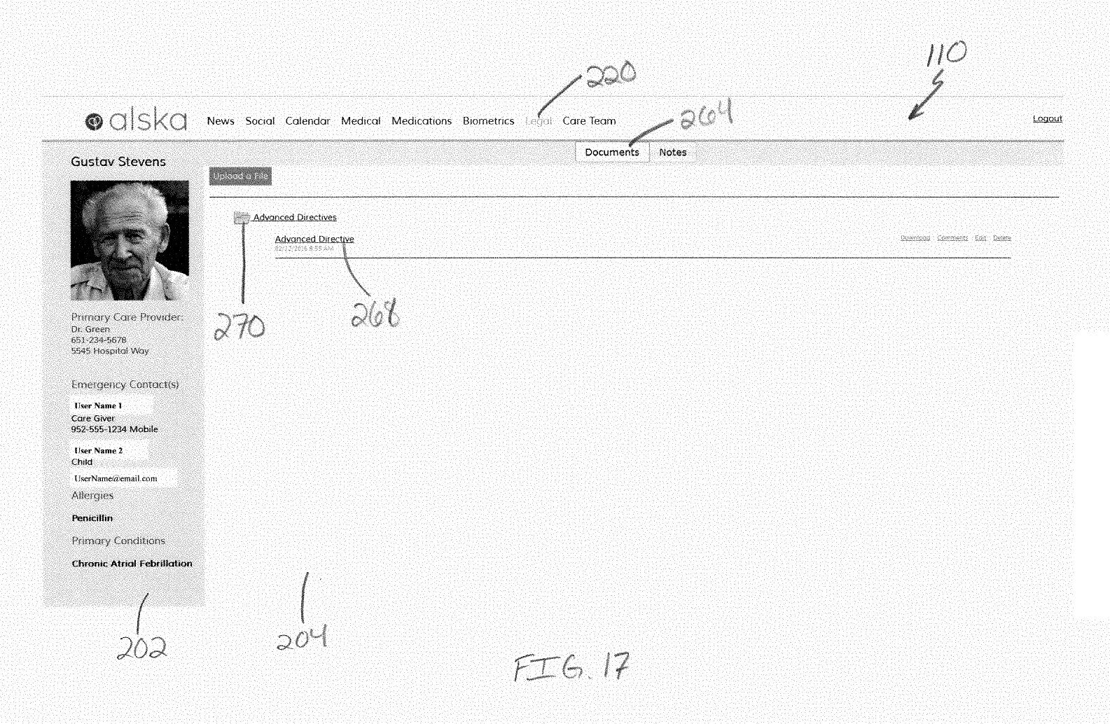

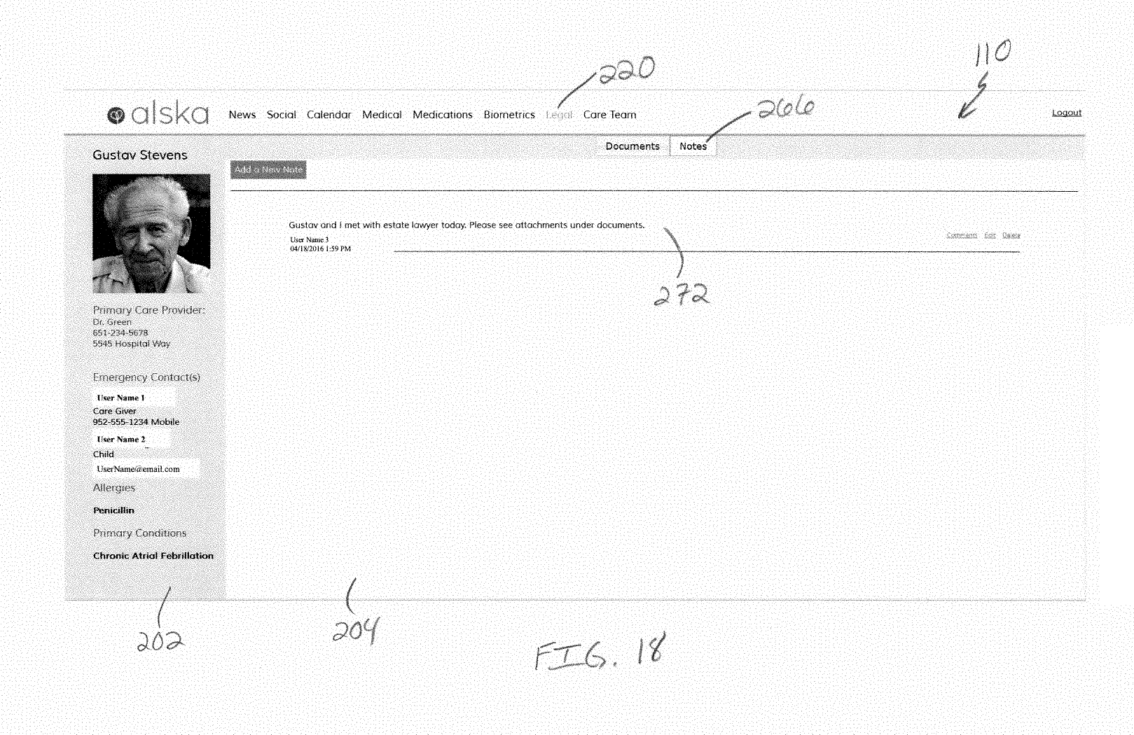

FIG. 17 shows an example of the legal page of the user interface 110, accessible by the legal tab 220. In some embodiments, the legal page may have one or more tabs, pages, or views. For example, under a documents tab 264, the legal page may display one or more legal documents 268 related to the patient's care or wellbeing. An example of a legal document 268 may be an advanced directive for the patient. Some users 105 may have access permissions for adding legal documents 268, or editing, deleting, and/or commenting on legal documents. In some embodiments, legal documents 268 may be uploaded in a manner similar to that described above with respect to the medical page and shown in FIG. 10. Additionally, some users 105 may have the option to download a copy of a legal document 268 accessible via the documents tab 264. In some embodiments, legal documents 268 may be organized into folders 270. Examples of folders 270 for legal documents include advanced directives, will and living will, power of attorney, miscellaneous, care and living, and banking and finance. In some embodiments, users may have the option to customize available or viewable folders 270 in which legal documents 268 may be organized. As shown in FIG. 18, the legal page may additionally have a notes tab 266 in some embodiments. Under the notes tab 266, the legal page may display one or more notes 272 related to legal matters. For example, a user 105 may wish to add a note to notify other users regarding new legal documents 268 added or forthcoming legal documents. Some users 105 may have the ability to add new notes 272, comment on notes, or edit and/or delete notes. The legal page may generally allow users 105 to maintain and access a record of current legal documents related to the patient's care.

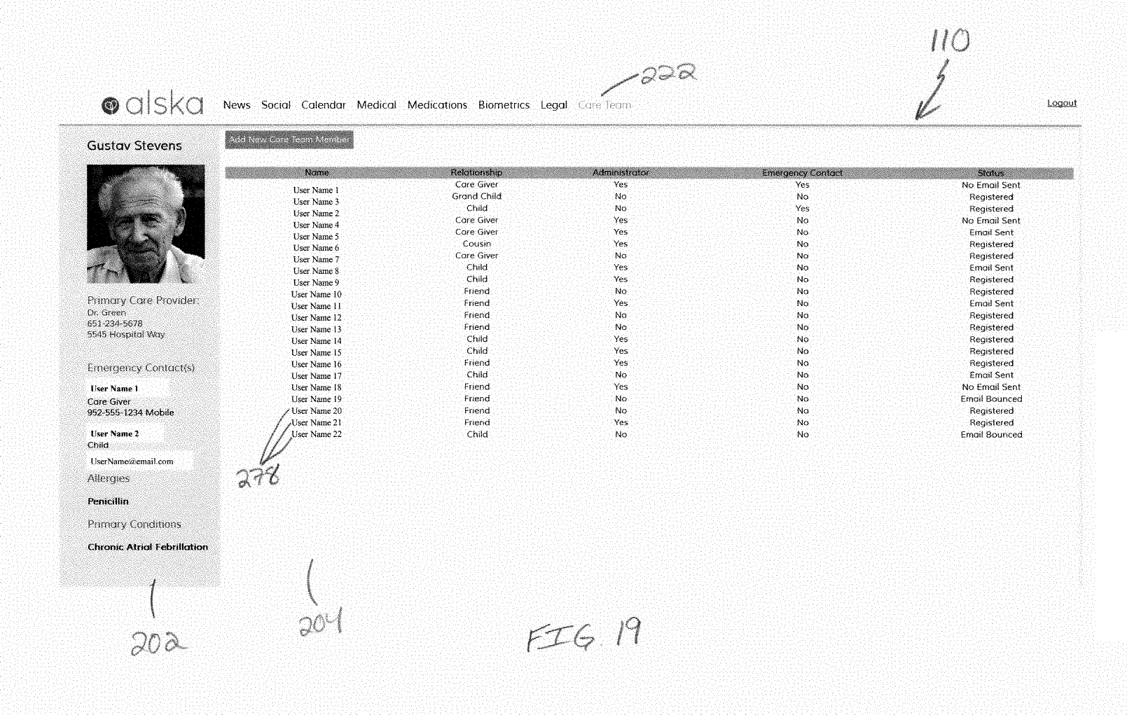

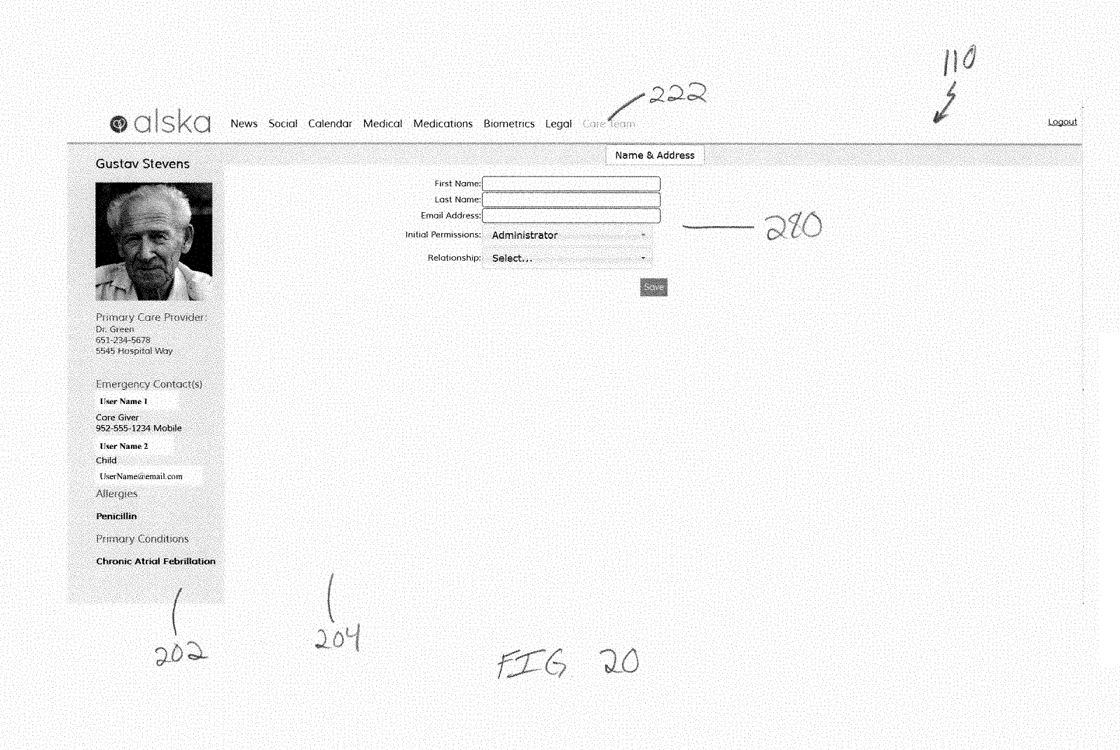

FIG. 19 shows an example of the care team page of the user interface 110, accessible by the care team tab 222. The care team page may display a list of care team members 278 who may be users 105 with at least some level of access to the user interface 110. The care team page may list the name of each care team member 278, each care team member's relationship to the patient, whether the member is an administrator having administrative access, whether the member is an emergency contact for the patient, and the member's registration status for the user interface 110. Some users 105 may have the ability to add new care team members 278 and/or edit information about a care team member and/or delete care team members. FIG. 20 shows a new care team member window 280, wherein a new care team member 278 may be added to the system 100 or an existing care team member may be edited. The new care team member window 280 may have fields for the new (or existing) member's name, email address or other contact information, access permissions, and relationship to the patient. Permissions and relationship may be selected via, for example, a drop down list of predetermined permissions and/or relationships or, in some embodiments, may be customizable for any given user. As described above, for example, preset selectable permission levels for a care team member 278 may include administrator, family member, friend, personal care assistant, and medical professional, each with varying levels of access as to which tabs they can access and/or what data they can view, add, edit, or delete. In some embodiments, when a new care team member 278 is added to the system 100, the care team member may receive an email or other message whereby the new care team member may verify his or her information. In this way, the system 100 may provide for secure means for adding new users 105. Some users 105 may additionally have the ability to delete care team members 278. Deleting a care team member 278 may revoke the member's ability to access the user interface 110. Some users 105 may also be able to edit a care team member's access permissions from the care team page.

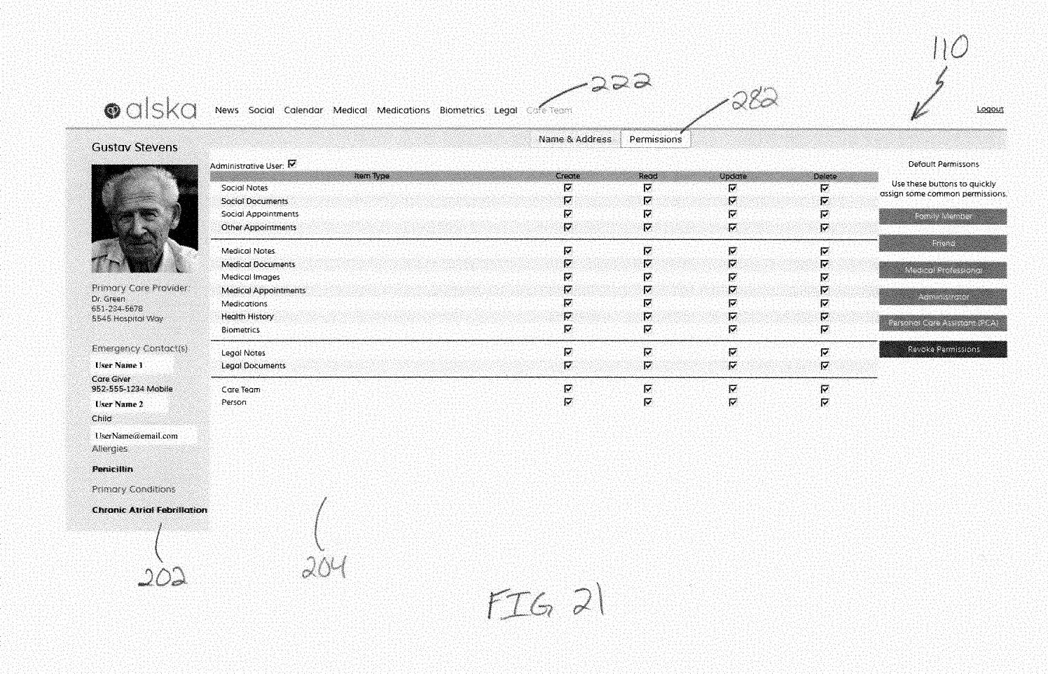

As described above, different users 105 may have different access permissions through the user interface 110. It may be appreciated that access permissions may be set globally, such that a user has the same permissions for each page of the user interface 110 in some embodiments. In other embodiments, access permissions may be set for individual pages or tabs of the user interface 110. For example, some users may be permitted to add new posts or comments to the social page of the interface 110, accessible via the social tab 210, but may have more restricted view only access or no access to other pages of the user interface, such as the medications page accessible via the medications tab 216. FIG. 21, for example, shows a permissions tab 282 whereby a user, such as an administrator, may control particular access permissions of a care team member 278. As shown, the administrator may select whether the care team member 278 has create, read, update, and/or delete permissions for each of several components of the user interface 110. The administrator may customize a care team member's access by selecting the various permissions for each component of the user interface 110, or in some embodiments, the administrator may select from a list of preset permission levels 284. As described above, the preset permission levels 284 may include, for example, administrator, family member, friend, medical professional, and personal care assistant. Selecting a preset permission level 284 may automatically set particular create, read, update, and delete permissions for the various components of the user interface 110. In other embodiments, other preset permission levels may be 284 available.

Additionally, aspects of the system 100 may be password protected or otherwise require user access information in some embodiments. For example, as described above, the user interface 110 may prompt a user for login information, such as but not limited to a username and password, before providing access to the system 100. Additionally or alternatively, particular tabs, pages, screens, windows, views, data, documents, communications, settings, or other elements may be password protected or otherwise require access information from at least some users. That is, in some embodiments, particular tabs, pages, screens, windows, views, data, documents, communications, settings, or other elements may be accessible only to users having an appropriate password or other verifiable access information. Some or all users, including in some embodiments users who otherwise have view, add, edit, and/or delete permissions for the particular element(s), may be prompted for a password or other access information to access such tabs, pages, screens, windows, views, data, documents, communications, settings, or other elements.

It may be appreciated that a system of the present disclosure may provide for improved monitoring and tracking of the patient's care or wellbeing and may allow for a team approach to care. Using a system of the present disclosure, family members friends, and other care team members, regardless of their physical location, may have convenient and secure access to care data and may be able to easily communicate with one another regarding the patient's care or wellbeing. Doctors, nurses, care givers, and other health professionals may have the ability to easily, securely, and privately communicate with the patient's family regarding the patient's care. Systems of the present disclosure may allow multiple parties to work together in the daily or ongoing care of the patient. Such systems may be particularly beneficial for elderly patients, patients in an assisted living facility, patients receiving in-home care, hospital patients, patients with a mental or physical disability, or other individuals receiving any type of medical care or assistance.

For purposes of this disclosure, any system, platform, or module described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, such as the user interface 110, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices or databases. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A system for facilitating care of a patient, the system comprising:
a database storing medical data for the patient;
a platform communicatively coupled to the database, the platform comprising:
an access control module for authenticating user credentials, the access control module further controlling read and write access for users by providing a plurality of assignable user access levels; and
a patient data module for processing medical data for the patient; and
a user interface accessible by one or more users, the user interface comprising:
a social page for facilitating communication between users;
a medical page for accessing medical data for the patient; and
a care team page for accessing data related to a care team, wherein the care team comprises one or more users;
wherein each of the one or more users has an assigned access level for each of the social page, medical page, and care team page.

2. The system of claim 1, wherein the plurality of user access levels comprises:
an administrator access level permitting a user the ability to view, add to, edit, and delete content on each of the social page, medical page, and care team page, the administrator access level further permitting a user the ability to add and delete users from the care team and assign access levels for users;
a family member access level permitting a user the ability to view, add to, edit, and delete content on at least the social page, and restricting access to edit and delete content on the care team page; and
a medical professional access level permitting a user the ability to view, add to, edit, and delete content on at least the medical page, and restricting access to edit and delete content on the care team page.

3. The system of claim 2, wherein the plurality of user access levels further comprises a friend access level permitting a user the ability to view, add to, and edit content on the social page, and restricting access to edit and delete content on each of the medical page and care team page.

4. The system of claim 1, wherein the social page displays communicative posts made by users.

5. The system of claim 1, wherein at least one of the one or more users can upload documents to the medical page.

6. The system of claim 1, wherein the platform further comprises an analytics module for analyzing the medical data.

7. The system of claim 1, wherein the platform further comprises an alerts module for sending alerts to at least one of the one or more users.

8. The system of claim 1, wherein the user interface further comprises a medications page for accessing data related to current medications of the patient, and wherein each of the one or more users has an assigned access level for the medications page.

9. The system of claim 1, wherein the user interface further comprises a biometrics page for accessing biometrics data for the patient, the biometrics data comprising data related to at least one of: the patient's blood pressure, the patient's blood sugar, the patient's daily activity, the patient's heart rate, the patient's temperature, the patient's weight, the patient's pain scale, the patient's oxygen saturation or use, the patient's CA 125, the patient's inhibin, and the patient's INR, and wherein each of the one or more users has an assigned access level for the biometrics page.

10. The system of claim 1, wherein the user interface further comprises a calendar page for accessing scheduling data for the patient, and wherein each of the one or more users has an assigned access level for the calendar page.

11. The system of claim 1, wherein the user interface further comprises a news page for accessing news data related to care of the patient, and wherein each of the one or more users has an assigned access level for the news page.

12. The system of claim 1, wherein the user interface further comprises a legal page for accessing legal data for the patient, and wherein each of the one or more users has an assigned access level for the legal page.

13. A user interface for facilitating care of a patient and providing one or more users with access to health data for the patient, the interface comprising:
a social page for facilitating communication among the users;
a medical page for accessing medical data for the patient; and
a care team page for accessing data related to a care team, the care team comprising the one or more users;
wherein access to the user interface is controlled by a plurality of assignable user access levels, each user access level comprising, for each of the social page, medical page, and care team page, at least one of read and write permissions.

14. The user interface of claim 13, wherein the plurality of user access levels comprises:
an administrator access level permitting a user the ability to view, add to, edit, and delete content on each of the social page, medical page, and care team page, the administrator access level further permitting a user the ability to add and delete users from the care team and assign access levels for users;
a family member access level permitting a user the ability to view, add to, edit, and delete content on at least the social page, and restricting access to edit and delete content on the care team page; and
a medical professional access level permitting a user the ability to view, add to, edit, and delete content on at least the medical page, and restricting access to edit and delete content on the care team page.

15. The system of claim 14, wherein the plurality of user access levels further comprises a friend access level permitting a user the ability to view, add to, and edit content on the social page, and restricting access to edit and delete content on each of the medical page and care team page.

16. The user interface of claim 13, further comprising a medications page for accessing data related to current medications for the patient, wherein each user access level comprises, for the medications page, at least one of read and write permissions.

17. The user interface of claim 13, further comprising a biometrics page for accessing biometrics data for the patient, the biometrics data comprising data related to at least one of: the patient's blood pressure, the patient's blood sugar, the patient's daily activity, the patient's heart rate, the patient's temperature, the patient's weight, the patient's pain scale, the patient's oxygen saturation or use, the patient's CA 125, the patient's inhibin, and the patient's INR, wherein each user access level comprises, for the biometrics page, at least one of read and write permissions.

18. The user interface of claim 13, further comprising a calendar page for accessing scheduling data for the patient, wherein each user access level comprises, for the calendar page, at least one of read and write permissions.

19. The user interface of claim 13, further comprising a news page for accessing news data related to care of the patient, wherein each user access level comprises, for the news page, at least one of read and write permissions.

20. The user interface of claim 13, further comprising a legal page for accessing legal data for the patient, wherein each user access level comprises, for the legal page, at least one of read and write permissions.
